(19) United States
(12) Patent Application Publication
(10) Pub. No.: US 2025/0193204 A1
(43) Pub. Date: Jun. 12, 2025

(54) SYSTEM AND METHOD FOR AUTHORIZATION CODE LOCATION VERIFICATION

(71) Applicant: Wells Fargo Bank. N.A., San Francisco, CA (US)

(72) Inventors: Crystal Banks Grossnickle, Denver, NC (US); Samuel Steven Feeback, Charlotte, NC (US); Nicola A. Maiorana, Charlotte, NC (US); Lakshmi Manasa Mangipudi, Charlotte, NC (US)

(21) Appl. No.: 18/537,141

(22) Filed: Dec. 12, 2023

(51) Int. Cl. H04L 9/40

(52) U.S. Cl. CPC H04L 63/107; H04L 63/083; H04L 63/0876

(57) ABSTRACT

A method may include receiving, over a network interface, a login request from a requesting computing device, the login request associated with a user account; detecting a location of the requesting computing device; generating using a processing unit, an authorization code; transmitting the authorization code to a code receiving device, the code receiving device associated with the user account; detecting a location of the code receiving device; comparing, using the processing unit, the location of the requesting computing device to the location of the code receiving device; determining, based on the comparing, the location of the requesting computing device and the location of the code receiving device are different; and generating an authorization response to the login request based on the determining.

### BACKGROUND

The proliferation of online data storage and transactional activities requires robust security measures to safeguard user accounts from unauthorized access and cyber threats. Online account security is critical for preventing data breaches, which can lead to severe consequences such as identity theft, financial loss, and reputational harm.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is a diagrammatic illustration of an account takeover attack, according to various examples.

FIG. 2 is an illustration of components of a client device and an application server, according to various examples.

FIG. 3 is data flow diagram of a method of processing a login request, according to various examples.

FIG. 4 is a block diagram illustrating a machine in the example form of a computer system, within which a set or sequence of instructions may be executed to cause the machine to perform any one of the methodologies discussed herein, according to various examples.

### DETAILED DESCRIPTION

In the following description, numerous specific details are set forth to provide a thorough understanding of some example embodiments. It will be evident, however, to one skilled in the art that the present invention may be practiced without these specific details.

Throughout this disclosure, components may perform electronic actions responding to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presenting may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in other instances, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be described as being configured to receive an input string. In this context, “configured to” may mean presenting a user interface element capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query for a database.

User account security is an important aspect of providing online services. One way in which an online service may provide security is through the use of two-factor authentication (2FA). 2FA introduces an additional security layer beyond the conventional username and password authentication model. A 2FA system operates on the principle of dual verification, requiring the user to provide two distinct forms of authentication evidence. The first factor is generally knowledge-based, typically a password or a PIN. The second factor is possession-based, often represented by a dynamically generated code sent to a user's mobile device or generated by a dedicated hardware token.

The effectiveness of 2FA lies in its ability to reduce the risk associated with compromised passwords significantly. By necessitating a second form of verification, which is typically time-sensitive and unique to each login attempt, 2FA systems drastically decrease the likelihood of unauthorized account access. Even when malicious entities obtain a primary password, the absence of the second authentication factor prevents successful account penetration.

However, 2FA systems may be defeated by malicious actors using social engineering attacks. The social engineering attacks may take several forms. For example, in a phishing attack, a user may receive a fraudulent email or message that appears to be from a trusted source, asking them to confirm their identity by providing a 2FA code that they just received. A subset of phishing is voice phishing, in which the malicious actor pretends to be from an online service and convinces the user to relay the code over the phone. In another variant, the malicious actor may pretend an emergency requires the user to provide the code.

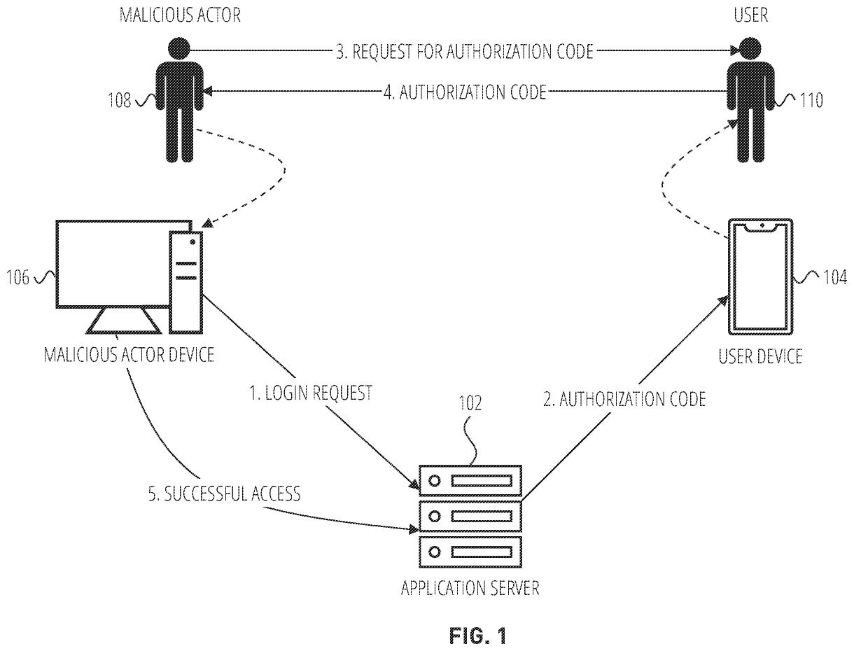

FIG. 1 is a diagrammatic illustration of an account takeover attack, according to various examples. The account takeover attack may be a social engineering attack, as described above. For example, consider that user 110 has an account with application server 102. As part of the registration process for the user account, user 110 may have given application server 102 their phone number.

Now consider that malicious actor 108 uses malicious actor device 106 to perform an action (e.g., logging in, resetting a password) for the user's account. In response to the action, application server 102 may require a 2FA code. Accordingly, before or at the time application server 102 requests a 2FA code, malicious actor 108 may initiate a call or messaging session with user 110 pretending to be a representative of the online service provided by application server 102. Malicious actor 108 may trick user 110 into relaying the 2FA code sent from application server 102 to user device 104 to malicious actor 108. Using the 2FA code, malicious actor 108 may log in to the user's account using the received 2FA. At this point, the malicious actor will have successfully taken over the user account and could lock the actual user out of their account.

Online services may have risk detection systems that quantify whether a user request is genuine (e.g., coming from a real user). For example, if a login request is received at application server 102 from a location where user 110 has not logged in, the risk may be higher than from a previously used location. Other high-risk activities may be when the user is attempting an action that the user has yet to perform in the past or changing the user's password. Generally, when the risk is high, the online service may require additional authentication information, such as a 2FA. However, it is also these high-risk actions that are susceptible to phishing attacks as if the system receives the correct 2FA code, the user account may be considered low risk.

Accordingly, existing authentication systems are deficient in these account takeover attacks. Described herein are systems and methods to lessen or eliminate the chance of a successful takeover by taking into consideration the location of the code receiving device (e.g., user device 104) and comparing it to the location of the login request (or other user account action) that has necessitated a 2FA code. In addition to the location of the code receiving device, other signals may be used to assess the risk that a 2FA code received by an online service may result from a phishing attack. For example, the user's past login locations and device fingerprints may be compared with a current login request's location and device fingerprint.

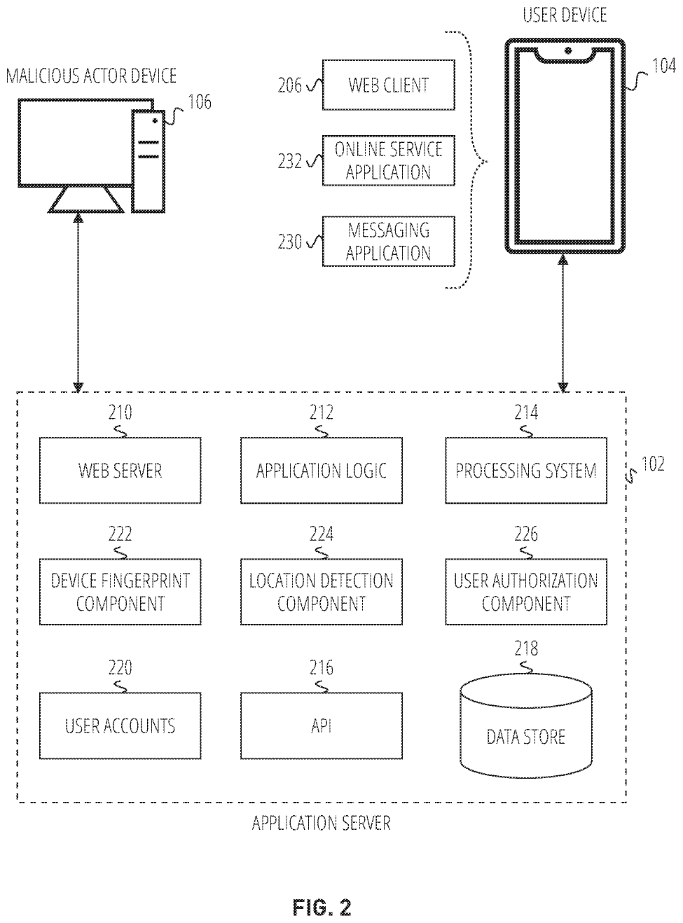

FIG. 2 is a network schematic illustration of an application server 102, a user device 104, and a malicious actor device 106, according to various examples. Application server 102 includes web server 210, application logic 212, processing system 214, device fingerprint component 222, location detection component 224, user authorization component 226, user accounts 220, API 216, and data store 218. User device 104 includes web client 206, online service application 232, and messaging application 230.

In various examples, application server 102 provides an online service. The online service may be for online banking, e-commerce, messaging, or social media, among others. A user may create an account with the online service, which may be stored as part of user accounts 220. The user may use the online service via devices such as user device 104. The online service may include more than one interface for its users. For example, the online service may be implemented as a web application interface served by web server 210 and accessed via a web browser (e.g., web client 206). The online service may also be accessed via an application (e.g., online service application 232) installed via an app store on user device 104.

User device 104 may be a computing device which may be but is not limited to, a smartphone, tablet, laptop, multi-processor system, microprocessor-based or programmable consumer electronics, game console, set-top box, or other device that a user utilizes to communicate over a network. In various examples, a computing device includes a display module (not labeled) to display information (e.g., in the form of specially configured user interfaces). In some embodiments, computing devices may comprise one or more of a touch screen, camera, keyboard, microphone, or Global Positioning System (GPS) device.

Application server 102 is illustrated as separate elements (e.g., components). However, a single element may perform the functionality of multiple individual elements. An element may represent computer program code executable by processing system 214. The program code may be stored on a storage device (e.g., data store 218) and loaded into the memory of the processing system 214 for execution. Portions of the program code may be executed in parallel across multiple processing units. A processing unit may be one or more of a core of a general-purpose computer processor, a graphical processing unit, an application-specific integrated circuit, or a tensor processing core operating a single device or multiple devices. Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

User device 104 and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

In some examples, the communication may occur using an application programming interface (API) such as API 216. An API provides a method for computing processes to exchange data. A web-based API (e.g., API 216) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data (e.g., user preferences of a user account) stored in a database (e.g., data store 218).

APIs may also be defined in frameworks provided by an operating system (OS) to access data in an application that an application may not regularly be permitted to access. For example, the OS of user device 104 may define an API call to obtain the current location of user device 104. Online service application 232 may use the API call to relay the location to application server 102. In another example, an application provider may use an API call to request to be authenticated using a biometric sensor of user device 104. By segregating any underlying biometric data—e.g., by using a secure element—the risk of unauthorized transmission of the biometric data may be lowered. Similarly, by requiring the location information to be obtained via an OS API call, the user may decide whether to allow location access at a device or application level.

Data store 218 may store data that is used by application server 102. Data store 218 is depicted as a singular element but may be multiple data stores. The specific storage layout and model used by data store 218 may take several forms-indeed, data store 218 may utilize multiple models. Data store 218 may be but is not limited to, a relational database (e.g., SQL), a non-relational database (NoSQL), a flat-file database, an object model, a document details model, a graph database, shared ledger (e.g., blockchain), or a file system hierarchy. Data store 218 may store data on one or more storage devices (e.g., a hard disk, random access memory (RAM), etc.). The storage devices may be in standalone arrays, part of one or more servers, and located in one or more geographic areas.

Application server 102 may include web server 210 to enable data exchanges with user device 104 via web client 206 or online service application 232. Although generally discussed in the context of delivering webpages via the Hypertext Transfer Protocol (HTTP), other network protocols may be utilized by web server 210 (e.g., File Transfer Protocol, Telnet, Secure Shell, etc.). A user may enter a uniform resource identifier (URI) into web client 206 (e.g., the INTERNET EXPLORER® web browser by Microsoft Corporation or SAFARI® web browser by Apple Inc.) that corresponds to the logical location (e.g., an Internet Protocol address) of web server 210. In response, web server 210 may transmit a web page rendered on a client device's display device (e.g., a mobile phone, desktop computer, etc.).

Additionally, web server 210 may enable users to interact with the online service using one or more web applications provided on a transmitted web page. A web application may provide user interface (UI) components rendered on a display device of user device 104. The user may interact (e.g., select, move, enter text into) with the UI components, and, based on the interaction, the web application may update one or more portions of the web page. A web application may be executed in whole or in part locally on user device 104. The web application may populate the UI components with data from external or internal sources (e.g., data store 218) in various examples. In various examples, the web application may be presented via online service application 232.

The web application may be executed according to application logic 212. Application logic 212 may use the various elements of application server 102 to implement the web application. For example, application logic 212 may issue API calls to retrieve or store data from data store 218 and transmit it for display on user device 104. Similarly, data entered by a user into a UI component may be transmitted using API 216 back to the web server. Application logic 212 may use other elements (e.g., device fingerprint component 222, location detection component 224, user authorization component 226, etc.) of application server 102 to perform functionality associated with the web application as described further herein.

User accounts 220 may include user profiles on users of application server 102. A user profile may include credential information such as a username and hash of a password. A user may enter their username and plaintext password to a login page of application server 102 to view their user profile information or interfaces presented by application server 102 in various examples.

A user account may also store the communication preferences of the user. For example, a communication preference may identify what messaging application to use when application server 102 transmits a 2FA code. The messaging application may be via short messaging service (SMS), a messaging application that uses an open communication standard such as Rich Communication Service (RCS), as a push notification via online service application 232, or a third-party message application (messaging application 230 such as WHATSAPP® by META, MESSAGES® by APPLE, etc.). For example, a drop-down menu may be presented to the user via a web application with the available messaging applications. After selecting a messaging application, the user may enter (e.g., from an input box) contact information (e.g., username, phone number) for contacting the user via the selected messaging application.

The user account may also store past login locations of the user. A location may be determined in several ways using location detection component 224. For example, upon receiving a login request, location detection component 224 identifies the IP address (e.g., from an IP packet header or log) associated with the device initiating the request. This IP address may then be queried against a database (e.g., part of data store 218) designed to map IP addresses to geographic locations. In various examples, location detection component 224 may issue an API call to an external service with the IP to retrieve the location data. The resulting location data may range from general (country or city) to more specific (such as a particular area within a city).

If online service application 232 is used, the location may be determined based on a location request API call to the OS of user device 104. The user may have granted location access to online service application 232 before a login request. Accordingly, after the user has logged in, the location of user device 104 may be transmitted to application server 102 and stored in the user's account.

A user account may also identify computing devices associated with the user. For example, users may register one or more phones, desktop computers, tablets, or laptops with application server 102. Registering may include authorizing application server 102 to retrieve data from these devices, such as location data, browser history, etc. Users may revoke access to such data anytime by updating their user profiles. The data may be gathered via an application (e.g., online service application 232) installed on one of the registered devices, such as by downloading an application from an app store associated with their mobile phone platform.

In addition to storing the login location, a device fingerprint may be made (e.g., using device fingerprint component 222) of the device used for the login. For example, a device fingerprint may include basic information such as the device's IP address, browser type and version, operating system, and language from HTTP request headers. Additional information may be used as part of the device fingerprint, such as which plugins or extensions are installed, timezone, screen resolution, Virtual Private Network (VPN) type, etc. The information may be hashed to create a unique identifier of the device. Accordingly, after a while, a user account may have a record of location/device fingerprint pairs of the most common places a user logs into the online service and uses which type of device.

Furthermore, application server 102 may provide an interface for a user to enter preferred or future locations the user may visit. For example, consider the user planning to visit a foreign country. Usually, a login request from a foreign country would be a flag that someone may be trying to hack into a user's account. However, if the user identifies the location before leaving, the weight of the associated risk factor may be lowered for the identified location.

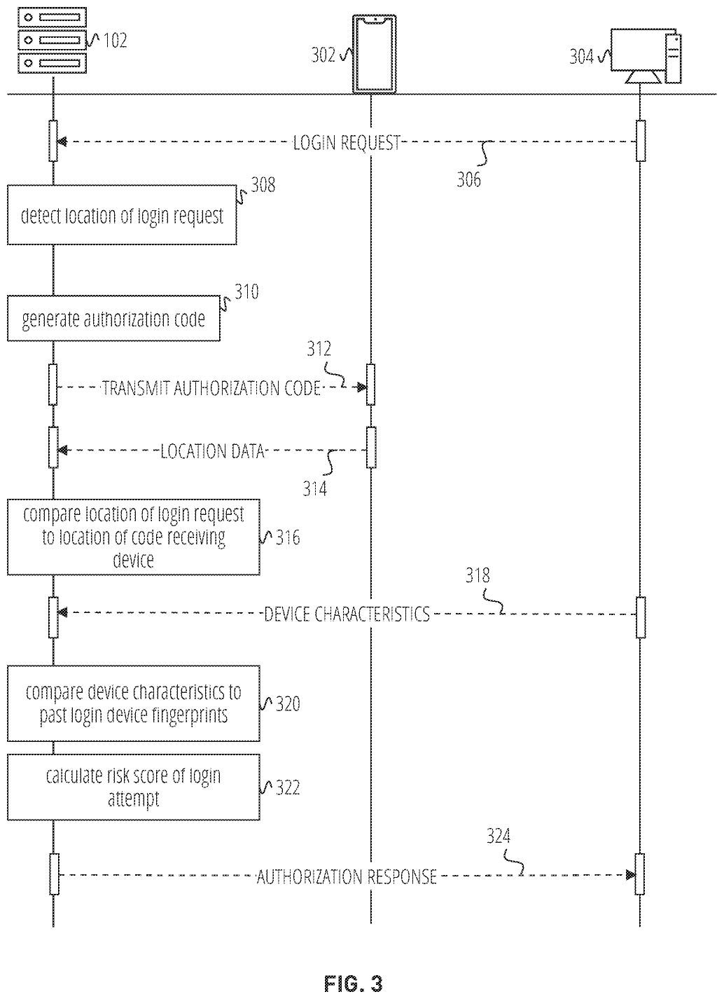

User authorization component 226 may include logic to process a login request from a device and is discussed further in the context of FIG. 3.

FIG. 3 is a data flow diagram of a method of processing a login request, according to various examples. The method is represented as a set of blocks and data flow lines that describe operation 306 to operation 324. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 3. The one or more processors may instruct other components of the computing device(s) to carry out the set of instructions. For example, the computing device may instruct a network device to transmit data to another computing device, or the computing device may provide data over a display interface to present a user interface. In some examples, the method's performance may be split across multiple computing devices using a shared computing infrastructure.

The data flow diagram includes three entities: application server 102 (as described previously), code receiving device 302, and requesting computing device 304. In various examples, code receiving device 302 and requesting computing device 304 may be the same. However, when requesting computing device 304 is used by a malicious actor, the two devices will differ. For example, code receiving device 302 may be a device such as described for user device 104 in FIG. 1, and requesting computing device 304 may be a device such as malicious actor device 106. The data flow diagram also includes an implied execution order from the top to bottom, but the order of the operations may differ. For example, operation 308 may be performed after operation 310.

At operation 306, a login request from requesting computing device 304 may be received at application server 102 over a network interface. The login request may be associated with a user account. For example, the login request may include a username and password. The login request may originate from a malicious actor attempting to log in to a user account of an online service provided by application server 102. The login request may be an initial login request to the online service or a stepped-up authorization login request. For example, sometimes, a malicious actor has gained illicit access to the correct username and password but is attempting an action with the online service that is particularly sensitive. These actions may include but are not limited to, changing the password or email of the user account, transferring funds beyond a certain amount, deleting an account, etc.

At operation 308, application server 102 may detect the location of the requesting computing device. For example, the IP address in the header of the login request may be used as an input to query an IP location database. The returned location from the database may include an estimated precision (e.g., ¼ mile, mile, city, zip code, etc.).

At operation 310, application server 102 may generate an authorization code. An authorization code may be a sequence of characters (e.g., letters, numbers, symbols) randomly generated using a pseudo-random number generator or a cryptographically secure pseudo-random number generator. The authorization code may be a set length (e.g., 4, 6, or 8 digits) and associated with the user account for a set validity period. After the validity period, the authorization code is no longer valid.

At operation 312, application server 102 may transmit the authorization code to a code receiving device (e.g., code receiving device 302). The code receiving device may be associated with the user account. For example, the phone number of code receiving device 302 may be stored in the user account. The preferred communication method for receiving authorization codes may be stored in the user account. The communication method may identify a messaging application preference, as discussed above. Consequently, operation 312 may include accessing (e.g., querying the user account) the messaging application preference associated with the user account and transmitting the authorization code via the messaging application. The messaging application may be a dedicated messaging application (e.g., WHATSAPP®, messaging client using RCS, MESSAGES by APPLE®, etc.) or a multipurpose application such as one provided by application server 102. The authorization code may be transmitted as a push notification via the messaging application.

The authorization code may be transmitted in several manners. For example, before transmitting the authorization code, a message may be transmitted to the code receiving device with a request for acknowledgment of the message. The message may state, “This [online service] will never ask for an authorization code over the telephone or through a messaging application. If someone is asking for the authorization code, please cease communication with them and go directly to our website for assistance. Please respond with ‘YES’ to acknowledge this information, and we will send you the code in the next message.” Application server 102 may then receive an indication of acknowledgment (e.g., a ‘Yes’ response or clicking of a link). Operation 312 may be performed in response to receipt of the indication. In another example, the user may click a link in a message transmitted to code receiving device 302 that brings the user to a website of application server 102. The website may present the authorization code after a user acknowledges a message like the above example.

In addition to the authorization code, the location of the requesting computing device may be transmitted to the code receiving device in a separate or the same message that includes the authorization code. A user may then look at the received location and realize that the online service would not operate in such a location and refuse to relay the code to the malicious actor. Furthermore, a message may be transmitted to the code receiving device that identifies the action (e.g., logging in, changing a password, transferring funds) being performed by the requesting computing device. The user may then realize that the action is not something a customer service representative would be attempting.

In various examples, application server 102 detects the location of the code receiving device. The location may be from location data transmitted from code receiving device 302 at operation 314. Some messaging applications include location information that is available asynchronously. Thus, one entity (e.g., application server 102) may request another entity's (e.g., code receiving device 302) location via the messaging application without sending the authorization code. As previously discussed, location data may also be available to applications installed on code receiving device 302 via OS API calls. Accordingly, the application may transmit the location data to application server 102. In some examples, the location data may come from a telecom provider if a user has granted authorization to use the location data.

As with the location of requesting computing device 304, the location of code receiving device 302 may be associated with an estimated precision. For example, location data from the OS of code receiving device 302 may be accurate to 100 ft. Yet, location data from some messaging applications may be provided just at the city level. The precision of telecom location data may vary based on the type and number of cellular towers visible to the requesting computing device 304.

In various examples, at operation 316, the location of the requesting computing device may be compared to that of the code receiving device. The comparison may include determining if a partial or total overlap exists between the location of the requesting computing device and the location of the requesting computing device by retrieving the estimated precision of both locations (e.g., from data store 218). For example, consider that the estimated precision of the location of the requesting computing device is ½ mile and the estimated precision of the location of the code receiving device is at the city level. Suppose at least a portion of the ½ radius of the location of the requesting computing device falls within the identified city of the code receiving device. In that case, the requesting computing device location and code receiving device location will be considered to overlap and be the same. If there is no overlap, the locations of the code receiving device and the requesting computing device may be considered different.

At operation 318, device characteristics of requesting computing device 304 may be transmitted to application server 102. The device characteristics may be part of an IP packet header or transmitted in response to queries from application server 102.

At operation 320, application server 102 (e.g., using device fingerprint component 222 of FIG. 2) may compare a device fingerprint of the requesting computing device to a stored device fingerprint associated with the user account. Hashes of characteristics (e.g., OS, browser type, etc.) of previous computing devices used to log into application server 102 may be stored in the user's account. Accordingly, the device characteristics of the current requesting computing device may be retrieved, and a hash computed. If the hash of the current requesting computing device does not match a previous hash, it may be a signal to application server 102 that a stepped-up authentication should be used.

At operation 322, application server 102 (e.g., using user authorization component 226 of FIG. 2) may calculate a risk score of the login attempt. In various examples, the risk score is not calculated until requesting computing device 304 has transmitted back the randomly generated authorization code. Risk scores may be calculated in different manners. For example, one way is to use a weighted sum of factors. Each factor may be given a score (e.g., 0.2). If the factor is present, the weight of the factor may be added to the risk score. Accordingly, one of the factors may be whether the location of the requesting computing device and the location of the code receiving device are different. The login attempt may be denied when the risk score exceeds a threshold.

Other factors may be if the device fingerprints match (e.g., 0.1 if they do not), if the location of the login request is new, the time of the login request, the frequency of login attempts from the IP associated with the requesting computing device, etc. In some examples, if a factor (e.g., the location factor) is present, the request may automatically be denied regardless of other factors. The weight of some factors may be adjusted based on data in a user's account. For example, a login request from a new geographic location would typically increase the risk score. However, if the new geographic location matches an intended location destination in the user's account, the weight of the new location factor may be lowered or eliminated.

At operation 324, application server 102 may generate an authorization response to the login request. For example, if the risk score of operation 322 exceeds a threshold, application server 102 may transmit a deny login request to requesting computing device 304.

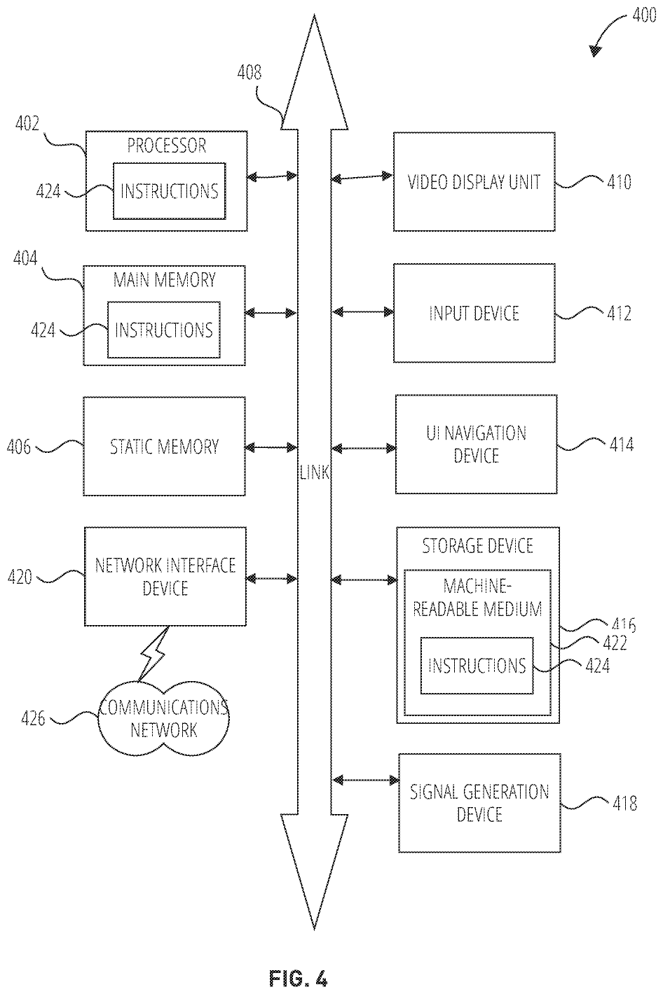

FIG. 4 is a block diagram illustrating a machine in the example form of computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408. The computer system 400 may further include a video display unit 410, an input device 412 (e.g., a keyboard), and a user interface UI navigation device 414 (e.g., a mouse). In one embodiment, the video display unit 410, input device 412, and UI navigation device 414 are incorporated into a single device housing such as a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensors.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed Database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 422 that excluded transitory signals.

The instructions 424 may further be transmitted or received over a communications network 426 using a transmission medium via the network interface device 420 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving, over a network interface, a login request from a requesting computing device, the login request associated with a user account;
detecting a location of the requesting computing device;
generating using a processing unit, an authorization code;
transmitting the authorization code to a code receiving device, the code receiving device associated with the user account;
detecting a location of the code receiving device;
comparing, using the processing unit, the location of the requesting computing device to the location of the code receiving device;
determining, based on the comparing, the location of the requesting computing device and the location of the code receiving device are different; and
generating an authorization response to the login request based on the determining.

2. The method of claim 1, wherein detecting the location of the requesting computing device is based on an internet protocol address of the login request.

3. The method of claim 1, wherein transmitting the authorization code to the code receiving device includes:
transmitting the authorization code as part of a push notification to an application installed on the code receiving device.

4. The method of claim 3, wherein detecting the location of the code receiving device includes:
receiving the location of the code receiving device from the application installed on the code receiving device.

5. The method of claim 1, wherein transmitting the authorization code to the code receiving device includes:
accessing a messaging application preference associated with the user account; and
transmitting the authorization code via the messaging application.

6. The method of claim 5, wherein detecting the location of the code receiving device includes requesting the location from the messaging application.

7. The method of claim 1, further comprising:
transmitting the location of the requesting computing device to the code receiving device.

8. The method of claim 1, further comprising:
before transmitting the authorization code, transmitting a message to the code receiving device including a request of acknowledgement of the message; and
receiving an indication of acknowledgment from the code receiving device, wherein transmitting the authorization code is in response to receiving the indication.

9. The method of claim 1, wherein generating the authorization response to the login request based on the determining includes:
comparing a device fingerprint of the requesting computing device to a stored device fingerprint associated with the user account.

10. The method of claim 1, wherein generating the authorization response to the login request based on the determining includes denying the login request.

11. A non-transitory computer-readable medium comprising instructions, which when executed by a processing unit, configure the processing unit to perform operations comprising:
receiving, over a network interface, a login request from a requesting computing device, the login request associated with a user account;
detecting a location of the requesting computing device;
generating an authorization code;
transmitting the authorization code to a code receiving device, the code receiving device associated with the user account;
detecting a location of the code receiving device;
comparing the location of the requesting computing device to the location of the code receiving device;
determining, based on the comparing, the location of the requesting computing device and the location of the code receiving device are different; and
generating an authorization response to the login request based on the determining.

12. The computer-readable medium of claim 11, wherein detecting the location of the requesting computing device is based on an internet protocol address of the login request.

13. The computer-readable medium of claim 11, wherein transmitting the authorization code to the code receiving device includes:
transmitting the authorization code as part of a push notification to an application installed on the code receiving device.

14. The computer-readable medium of claim 13, wherein detecting the location of the code receiving device includes:
receiving the location of the code receiving device from the application installed on the code receiving device.

15. The computer-readable medium of claim 11, wherein transmitting the authorization code to the code receiving device includes:
accessing a messaging application preference associated with the user account; and
transmitting the authorization code via the messaging application.

16. The computer-readable medium of claim 15, wherein detecting the location of the code receiving device includes requesting the location from the messaging application.

17. The computer-readable medium of claim 11, wherein the instructions, which when executed by the processing unit, further configure the processing unit to perform operations comprising:
transmitting the location of the requesting computing device to the code receiving device.

18. The computer-readable medium of claim 11, wherein the instructions, which when executed by the processing unit, further configure the processing unit to perform operations comprising:
before transmitting the authorization code, transmitting a message to the code receiving device including a request of acknowledgement of the message; and
receiving an indication of acknowledgment from the code receiving device, wherein transmitting the authorization code is in response to receiving the indication.

19. The computer-readable medium of claim 11, wherein generating the authorization response to the login request based on the determining includes:
comparing a device fingerprint of the requesting computing device to a stored device fingerprint associated with the user account.

20. A system comprising:
a processing unit; and
a storage device comprising instructions, which when executed by the processing unit, configure the processing unit to perform operations comprising:
receiving, over a network interface, a login request from a requesting computing device, the login request associated with a user account;
detecting a location of the requesting computing device;
generating an authorization code;
transmitting the authorization code to a code receiving device, the code receiving device associated with the user account;
detecting a location of the code receiving device;
comparing the location of the requesting computing device to the location of the code receiving device;
determining, based on the comparing, the location of the requesting computing device and the location of the code receiving device are different; and
generating an authorization response to the login request based on the determining.
